(19) United States
(12) Patent Application Publication
(10) Pub. No.: US 2025/0064257 A1
(43) Pub. Date: Feb. 27, 2025

(54) COOKWARE WITH SPLATTER CONTROL

(71) Applicant: Norman DING, Fenton, MO (US)

(72) Inventor: Norman DING, Fenton, MO (US)

(21) Appl. No.: 18/237,894

(22) Filed: Aug. 24, 2023

(51) Int. Cl. A47J 36/08

(52) U.S. Cl. CPC A47J 36/08

(57) ABSTRACT

The invention provides cooking systems that improve control over condensate generated from vapor and steam during cooking and storage. Further, the system according to the disclosure contained hereinwith provides easy user control over whether such condensate is discharged outside or inside the cooking chamber, or both.

### FIELD OF THE INVENTION

The invention relates to innovative cooking products and processes that can be used to enhance the quality of prepared food through management of oil splatter and vapor condensation.

### BACKGROUND OF THE INVENTION

In the art of cooking, especially in pan-frying or deep-frying food, it has long been recognized that when oil gets hot, any amount of water or other liquids intermixed therewith could cause excessive spattering. The hot splatter could easily escape the cooking vessel and land on people and surfaces around causing bodily harm or leaving a mess for time-consuming and tedious clean-up. Many solutions have been tried to solve this problem which involve management of oil splatter, oil fume and water vapor/condensation.

First, as seen in FIGS. 1A and 1B, a lid, often glass, has been used widely in the art to cover any kind of cookware and to block excessive splatter from escaping. However, such a lid also keeps vapor condensate inside, virtually all of which drips back down to the cooking content in the cookware and creates even more splatter as long as there is still hot oil around. Meanwhile, the steam and/or vapor inside the cookware intensifies with heat, which tends to overcook the food as the food is being steamed instead of being pan-fried. Some solutions are provided in this kind of lids though, for example, in U.S. Patent Publication No. 20050205577, holes are provided in the lid handle for hot steam and pressurized air to escape during cooking.

Second, people have used a splatter screen to cover up a splattering cookware. While such a screen, often made with a wired mesh surface, lets out hot air, steam and water vapor through its many openings, it also lets out some amount of the splatters. Moreover, it reduces or eliminates visibility of the food being cooked and lets out harmful oil fumes. U.S. Pat. No. 6,056,146 provides such an example.

Third, specially designed venting outlets or holes have been provided within cookware lids to vent out a certain amount of water vapor while blocking out most of the oil splatters. One of the early examples can be found in U.S. Pat. No. 2,348,507. A drawback in this kind of construction is that the inside surface of the lid generates condensates drops that drip back into the cooking vessel and the lid still lets out harmful oil fumes through its vents. While some of the more recent examples focus on providing patterned features inside the lid to try distribute the drip-back condensates as evenly as possible, see, e.g., U.S. Pat. No. 2,696,816 and U.S. Patent Publication No. 20230034305, the fundamental problem of cycling too much of the water in the steam back into the cooking surface remains unsolved.

A fourth solution that has been offered presents itself as splatter guards. See, U.S. Pat. No. 9,784,302. Such guards opt for a more vertically open configuration to let out all the steam from the cooking, but as a result, they only block splatter in small areas, leaving the rest unprotected. Further, splatter guards give a free pass for oil fumes to simply escape and emanate throughout the kitchen.

There remains a need for an effective way to both block oil splatter and remove unwanted water content from a cooking chamber without letting out harmful oil fumes. Moreover, because sometimes it is desired to have some water cycled back onto the food that is being cooked—to keep the food moist or to cook the food faster—an improved system preferably offers the operator the ability to control how much water is cycled back into the cookware or when to get rid of the water content.

### SUMMARY OF THE INVENTION

It is therefore, according to the disclosure contained herein, that an improved cooking system is provided. This novel system is able to achieve most or all of the following, depending on the particular embodiment: (a) blocking oil splatter from landing outside the cookware; (b) preventing, when desired, condensates from returning back into the cooking chamber; (c) allowing, when desired, condensates to return back into the cooking chamber; and (d) contains oil fumes inside the cooking chamber. This is largely achieved through the provision, in combination with a dome-like cover, of a drainage member that allows the collection and discharge of vapor condensation such that condensates, instead of returning into the cooking chamber and interacting with food content, is guided outside for disposal or inside for temporary storage. With the addition of an optional switch feature where condensates could also be guided for disposal inside the cooking chamber, the present invention provides the ability to control how much and when some water content from the vapor generated during cooking is returned to the cooking chamber. The present invention discloses multiple embodiments depending on where the inventive drainage member and various features are located.

In a first aspect, the drainage member is provided with the cover, where the invention relates to a cooking cover or lid useful in a cooking system, where the cover has a dome-like convex surface having an apex on top of a base rim below, a handle (e.g., a knob) disposed at said apex for handling said cover, and a drainage member disposed in proximity to said base rim for collecting condensate formed on an underside of said cover during cooking and storage. Further, said cover is configured to fit over a cooking vessel or apparatus forming a cooking chamber, and said drainage member defines at least one outward opening for discharging any condensate outside said cover, hence, the cooking system, and at least one inward opening for discharging any condensate inside said cover, and hence, the cooking system. Optionally and preferably, said drainage member further includes a switch, e.g., a two-way slide, that controls whether said drainage member discharges condensate through said at least one outward opening or said at least one inward opening.

In a feature, said drainage member initially discharges into at least one storage member, e.g., an annular gutter, for temporarily storing the condensation before any further discharges. In another feature, each outward opening is radially staggered from an inward opening. The storage member can be disposed inside or outside the cooking cover, or, when viewed together with the cooking vessel underneath, inside or outside the cooking chamber. In another feature, the cooking cover's convex surface is made of a transparent or semi-transparent material, e.g., glass. Alternately, it can be made of a non-transparent material, e.g., a metal such as aluminum alloy.

In a first aspect, said drainage/storage member is part of or otherwise fits onto the cooking cover. In a second aspect, said drainage/storage member is part of or otherwise fits onto the cooking vessel. In a third aspect, said drainage/storage member is a stand-alone element that is separable from both the cover and the vessel, but fits between the two when assembled.

Specifically, according to the second aspect of the invention, a cooking vessel is provided having a bottom that can be placed over a source of heat and a wall over said bottom terminating in a top rim above, and the drainage member according to principles of the present invention is disposed in proximity to said top rim of the vessel for collecting and discharging condensate or liquid received during use: said drainage member defines at least one outward opening for discharging any condensate or liquid outside said vessel and at least one inward opening for discharging any condensate or liquid inside said vessel, and said drainage member further includes a switch that controls whether said drainage member discharges condensate or liquid outside or inside said vessel. The cooking vessel is typically configured to fit underneath a cooking cover forming a cooking chamber where condensate is generated. The bottom of the vessel can be flat, e.g., as in a frying pan, a pot or a (deep) fryer, or curved, e.g., as in a wok.

According to the third aspect of the invention, a cooking system features a stand-alone ring member, where said ring member includes the drainage member according to principles of the present invention for collecting any liquid generated during use, and where said drainage member defines at least one outward opening for discharging any liquid outside said ring member and at least one inward opening for discharging any liquid inside said ring member. The drainage member may further include a switch that controls whether said drainage member discharges liquid outside or inside said ring member. The cooking system can further include (a) a cooking vessel for housing food items that includes a bottom that can be placed over a source of heat and a wall over said bottom terminating in a top rim above, and where the vessel's top rim is configured to fit underneath said ring member; and (b) a cooking cover having a dome-like convex surface with an apex on top of a base rim below, a handle disposed at said apex for handling said cover, and where said cover's base rim is configured to fit over said ring member. The three parts together form a cooking chamber.

In this aspect of the invention, similar to other aspects, the bottom of the cooking vessel can be flat or curved; the switch may include a two-way slide; and each outward opening is radially staggered from any inward opening.

In yet another aspect, the invention features simplified embodiments where the drainage member does not include a switch to control whether to drain condensates inside or outside. Instead, these alternate embodiments provide the structure and capacity to drain outside and/or inside constantly.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A shows a prior art example of a cooking cover. FIG. 1B illustrates how heat is conducted through the vapor-condensate-vapor cycle during cooking using the prior art cooking system.

FIG. 2A illustrates an exemplary embodiment of a cooking cover according to principles of the invention. FIG. 2B illustrates the cover shown in FIG. 2A over a pot to illustrate its functionality. Figure. 2C is an enlarged view of a part of FIG. 2B to show certain inventive details.

FIG. 3A illustrates a cross-section of part of a cooking cover embodiment equipped with a drainage member and fitted over a cooking vessel wall when the outward side drainage is switched to open. FIG. 3B is a cross-sectional view of part of the same cooking cover and cooking vessel assembly when the inward side drainage is switched to open. FIG. 3C provides a cross-sectional view of an alternative embodiment of a cooking cover of the invention fitted over a cooking vessel when an outward bottom drainage is switched to open.

FIG. 3D provides a cross-sectional view of another alternative embodiment of a cooking cover of the invention fitted over a cooking vessel when an outward bottom drainage is switched to open. FIG. 3E provides a partial, perspective view of the cooking cover of FIG. 3A minus the switch, showing the radially staggered positions of its outward and inward opening(s).

FIG. 4A provides a view of a switch embodiment within a storage member according to principles of the invention and switched to allow outward drainage. FIG. 4B provides a view of the same switch embodiment within the same storage member but switched to allow only inward drainage.

FIG. 5A illustrates a cross-section of part of a cooking vessel embodiment equipped with the drainage member and fitted underneath a cooking cover when an outward bottom drainage is switched to open. FIG. 5B is a cross-sectional view of part of an alternate cooking vessel embodiment, also assembled underneath a cooking cover, when an inward bottom drainage is switched to open.

And FIG. 6A illustrates a cross-section of part of a stand-alone ring member equipped with a drainage member and fitted underneath a cooking cover when an outward bottom drainage is switched to open. FIG. 6B is a cross-sectional view of part of an alternate stand-alone ring member equipped with a drainage member, also assembled underneath a cooking cover, when an inward bottom drainage is switched to open.

### DETAILED DESCRIPTION OF THE INVENTION

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward unless noted otherwise. Alternate embodiments may be devised without departing from the spirit or scope of the invention. Well-known elements of exemplary embodiments of the invention may not be described in detail or may be omitted so as not to obscure relevant features of the invention or, simply, for the economy of the disclosure.

As used in the specification and claims, the singular form “a”, “an”, or “the” includes plural references unless the context clearly dictates otherwise. For example, the term “a handle” includes a plurality of handles including mixtures of different kinds thereof. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent,” “provided for [a particular feature or element],” “except for [a particular feature or element],” or “wherein [a particular feature or element] is not present (included, etc.) . . . ”.

When a dimensional measurement is given for a part herein, the value is, unless explicitly stated or clear from the context, meant to describe an average for a necessary portion of the part, i.e., an average for the portion of the part that is needed for the stated purpose. Any accessory or excessive portion is not meant to be included in the calculation of the above value.

As used herein, the recitation of a numerical range for a variable is intended to convey that the invention may be practiced with the variable equal to any of the values within that range. Thus, for a variable which is inherently discrete, the variable can be equal to any integer value within the numerical range, including the endpoints of the range. Similarly, for a variable which is inherently continuous, the variable can be equal to any real value within the numerical range, including the endpoints of the range. As an example, and without limitation, a variable which is described as having values between 0 and 2 can take the values 0, 1 or 2 if the variable is inherently discrete, and can take the values 0.0, 0.1, 0.01, 0.001, or any other real values >0 and <2 if the variable is inherently continuous.

As used herein, “about” means within plus or minus 10%. For example, “about 1” means “0.9 to 1.1”, “about 2%” means “1.8% to 2.2%”, “about 2% to 3%” means “1.8% to 3.3%”, and “about 3% to about 4%” means “2.7% to 4.4%.”

As used herein, the term “coupled” means connected, although not necessarily directly, and not necessarily mechanically.

The following convention is used in describing various directions with respect to the inventive cooking system. The embodiments are described and explained in a setting where the pan or cookware on which the cover or lid, and possibly other parts are placed is by default set on a counter or another horizontal surface in an upright position as in normal use unless indicated otherwise. When the cooking system is in this upright, normal orientation, the following terms have the following meanings: the terms “up” or “upward” mean the vertical direction extending from the bottom of the cookware toward the top of the cookware and beyond; the terms “down” or “downward” mean the vertical direction that is the opposite of the “up” or “upward” direction—i.e., the vertical direction extending from the top of the cookware toward the bottom of the cookware; the terms “in” or “inward” means the horizontal direction from the periphery or side of the cookware toward the center of the cookware; and the terms “out” or “outward” means the opposite horizontal direction—i.e., the direction from the center of the cookware toward the periphery or side of the cookware. If a part or object is “above” or “over” another part or object, said part or object is in a position or location that is in the upward direction from the other part or object. Similarly, if a part or object is “below” or “underneath” another part or object, said part or object is in a position that is in the downward direction from the other part or object. These terms of reference are used for convenience only and are generally consistent with the orientation of the apparatus as it is shown in the drawings, but one should understand that these terms are relative to the way a device is positioned or viewed.

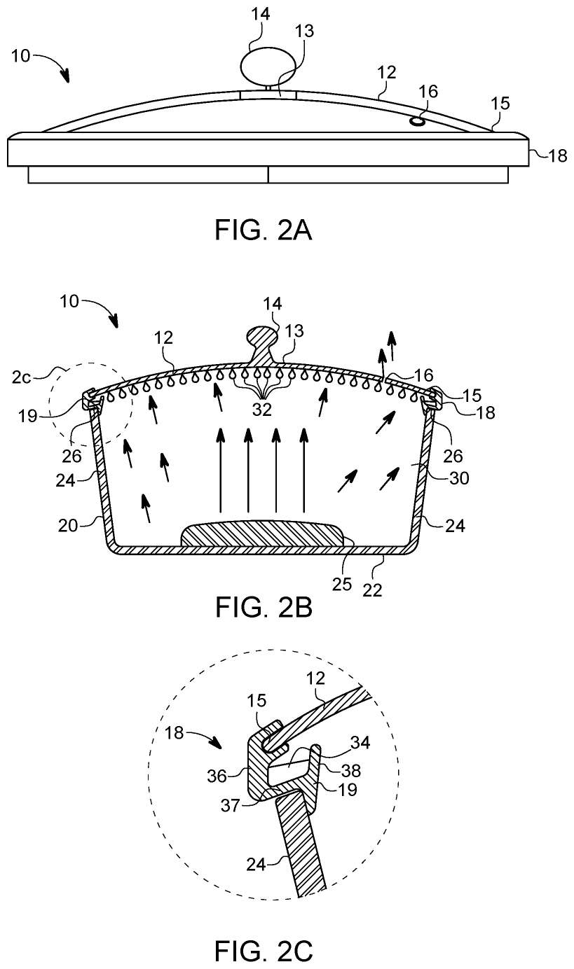

Described now are exemplary embodiments of the present invention. Referring first to FIGS. 2A-2C, there is shown a first exemplary embodiment of a cooking cover or lid 10 that is to be used in conjunction with a piece of cookware or cooking vessel 20, such as a pan, a wok, a pot, a skillet, or a (deep) fryer. The cooking vessel 20 typically includes (a) a vessel bottom 22 that can be placed over a source of heat, e.g., a stovetop, and (b) a vessel wall 24 above the vessel bottom 22 and terminating in a vessel top rim 26 above. The vessel bottom 22 can be largely flat (e.g., a pot, pan, or fryer), or curved (e.g., a wok). The cooking cover 10 of the invention typically includes a dome-like, convex surface 12 having an apex 13 on top of or above an annular base 15 that supports the convex surface from below. A handle 14 typically is provided at the apex 13, e.g., resembling a knob, for handling the cover. The surface 12 curves inward and can thus be described as convex with an apex 13 pointing upward toward the handle 14, or, with a largely flat top under the handle 14. The surface 12 typically resembles a dome, e.g., as part of a sphere, but can be of other geometric shapes as long as it forms an enclosed space, i.e., the cooking chamber 30, with the cooking vessel 20 below to hold food items 25. In an alternate embodiment sometimes used as the cover for a buffet tray or for a fryer, the cooking cover 10 has a quadrilateral base that fits onto a similarly shaped cooking vessel, and the handle can be at the top of a convex surface 12 or attached to somewhere else on the cooking cover, e.g., a side of the convex surface 12 or the base.

The surface 12 of the cooking cover is preferably made of a transparent or semi-transparent material, e.g., glass or plastic for visibility during cooking, but can be also made of a non-transparent material such as a metal, metal alloy, (e.g., aluminum, tin alloy, or stainless steel), or wood. While there is no limitations on the size of the cooking cover 10 according to the present invention, common sizes to accommodate cookware already on the market include covers with diameters of 6, 8, 10, 12, 14, and 16 inches. The underside of the surface 12 is where condensation normally takes place during cooking. There may be one or more optional vent openings 16 provided in the surface 12 to release some of the water vapor and pressure as seen in some prior art embodiments.

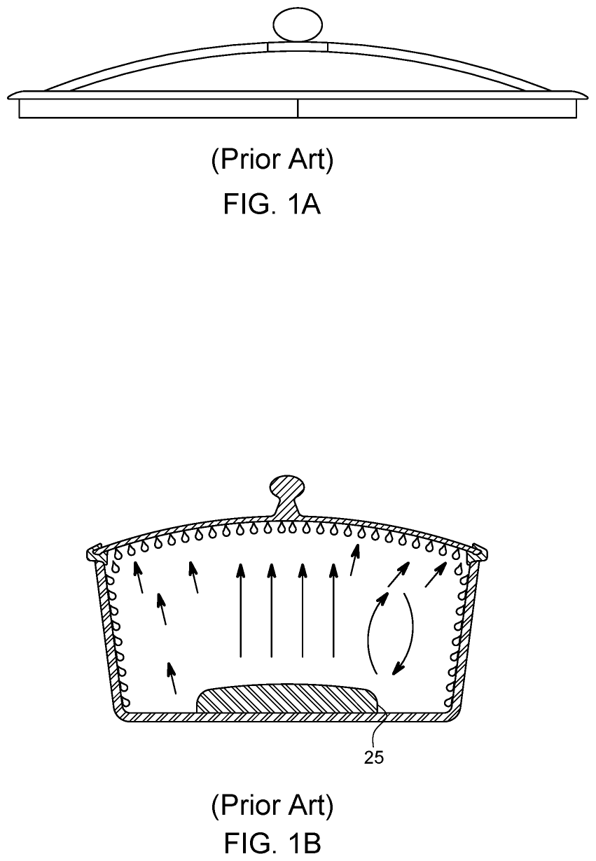

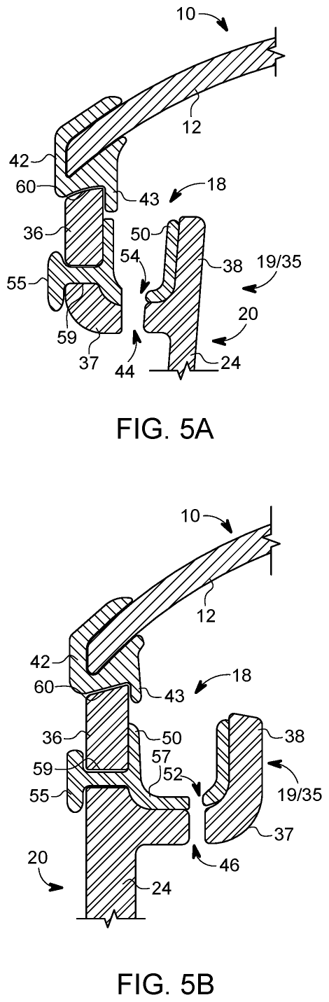

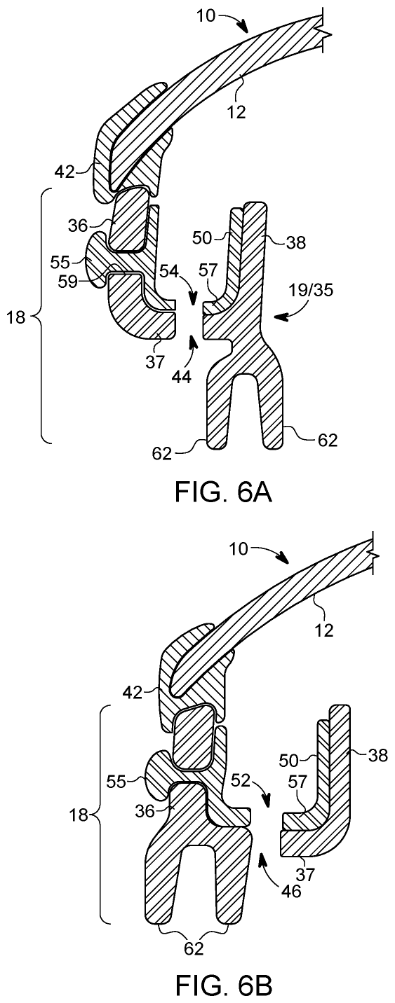

According to a central feature of the invention, near the base 15 of the cooking cover's convex surface 12 is provided a drainage member 18. As shown in the embodiment depicted in FIGS. 2A-2C, the drainage member 18 is provided as part of the cooking cover 10, but it can also be provided as a stand-alone part or part of the cooking vessel 20, as will be described in more details below (see FIGS. 5A, 5B, 6A, and 6B). As food items 25 are being heated, water vapor rises within the cooking chamber 30—while a small amount of vapor escapes from the vent 16, most will condensate on the underside of cover surface 12 as water droplets 32 which will glide outward down the underside of cover surface 12. When condensate droplets 32 reach the cooking cover's base 15, however, instead of sliding down along the cooking vessel wall 20 as in prior art systems (FIG. 1B), they are disposed by the drainage member 18 to be either collected and stored temporarily in a storage member 19 as a collection of liquid 34 or discharged either outside or inside the cooking system or both (details provided in connection with other figures below). On the one hand, when pan-frying or deep-frying is desired as the cooking method, condensate can be discharged outside the cover or the chamber, and water discharged this way is no longer recycled within the cooking system to avoid splatters. On the other hand, when steaming or stewing is desired, condensate can be discharged inside the cover or the chamber, and water continues to cycle within the cooking system, and helps conduct heat for the cooking process. Accordingly, the operator has the option and control over the cooking system in terms of how much water/vapor content is desired for the recipe as well as when to get rid of or retain water/vapor.

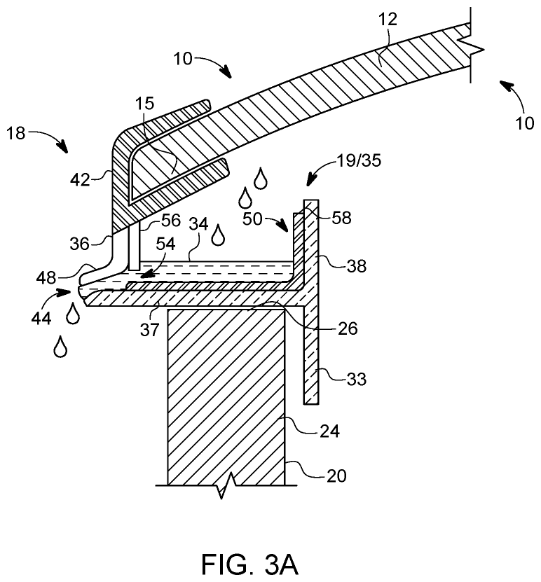

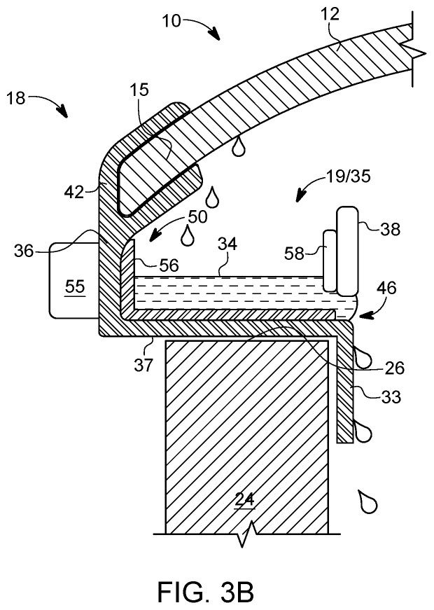

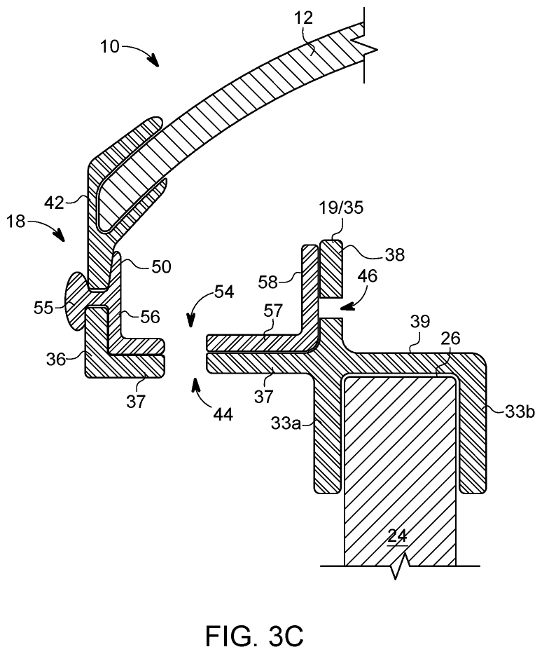

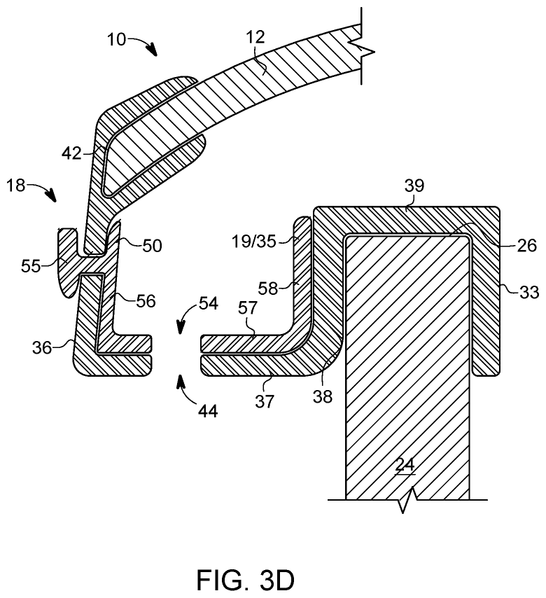

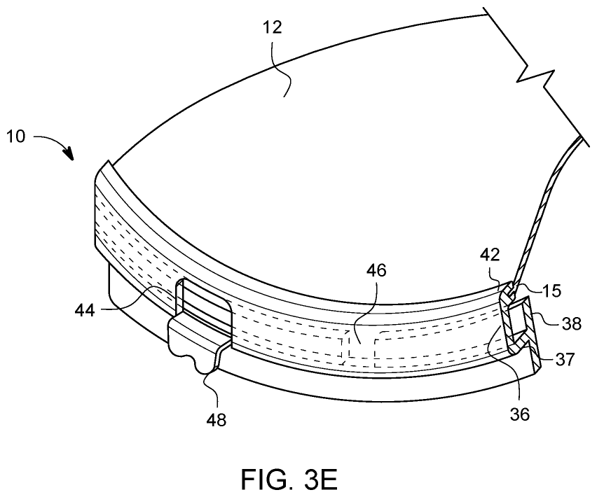

Referring now to FIGS. 3A-3E, details of various features of the drainage member 18 according to principles of the present invention are further explained. In an exemplary embodiment, the drainage member 18 includes a storage member 19, which, as illustrated, can be an annular gutter or a trough 35 of any shape and characteristic with a U-shaped cross-section that typically includes an outer side wall 36 and an inner side wall 38 connected through a floor 37. The floor 37 can sit over the top rim 26 of a matching cooking vessel 20 (FIGS. 3A and 3B), or it can hang outside of the cooking vessel 20 when the cover is assembled over the vessel (FIG. 3C). To facilitate the fitting, one or both of the gutter's inner wall 38 and outer wall 36 may extend downward to provide further structures or perimeters for the cooking vessel to fit in as part of an assembly. If both such extensions are provided, the cross-section of the gutter would be H-shaped. In the embodiment illustrated in FIGS. 3A and 3B, however, only the inner wall 38 has a downward extension 33. In the particular embodiment illustrated in FIG. 3C, the inner wall 38 has a downward extension with two prongs 33a and 33b that are connected by an extension bridge 39. And in the particular embodiment illustrated in FIG. 3D, the inner wall 38 has a parallel extension 33 connected by extension bridge 39 the extension bridge 39 can be configured to connect to the inner wall 38 anywhere along its length, e.g., at the top as shown here. All these extensions and related structures are included to help fit the cooking cover 10, more specifically, the drainage member 18, over the vessel wall 24 of the cooking vessel 20. For the embodiment illustrated in FIG. 3C, either one of the downward extensions 33a and 33b can be omitted without significantly compromising functionalities.

The storage member 19/annular gutter 35 may be made of any suitable material especially water-proof materials, e.g., a metal or metal alloy, rubber, silicone, or a plastic. In a preferred embodiment, the annular gutter 35 is made of stainless steel. While there are no limitations on their sizes, the storage member 19/annular gutter 35 should generally be large enough to hold some liquid before having to discharge but also not too large to add too much bulk to the assembly. In preferred embodiments, the storage member 19/annular gutter 35 has a width, as measured by the floor 37, and height, as measured by the inner wall 38, to be between about 0.25 inches (0.635 cm) and 0.50 inches (1.27 cm).

The annular gutter 35 is further fastened or otherwise connected to base 15 of the dome-like surface 12 of the cooking cover 10. In this example, such connection is made via a slotted reinforcement rim or border 42. Such connecting element may be integral with the drainage member 18, i.e., made of the same material or manufactured in the same industrial process as the rest of the drainage member 18 including the annular gutter, or made separately and even of a different material. For example, the slotted rim 42 may be made of rubber while the annular gutter 35 may be made of a metal or metal alloy. Adhesive may be also used for effecting the connection between the annular gutter 35 and the cover's dome-like surface 12 via the slotted rim 42. On the other hand, if the lower part or the entire dome 12 is made of the same material as the drainage member 18, then there may no longer need a special connection part like the slotted rim 42—instead, the dome 12 and the drainage member 18 can be made integral as one item, e.g., in extruded metal.

In addition, the drainage member 18 defines one or more discharge openings, which could include at least one outward opening 44 (FIGS. 3A, 3C and 3D) and/or at least one inward opening 46 (FIGS. 3B and 3C). In the embodiment illustrated in FIG. 3A, the outward opening 44 is in the side wall 36 whereas in the embodiment illustrated in FIG. 3C, an alternative outward opening 44 is shown to be disposed in the bridge 37 to drain directly downward in addition to or in replacement of the side opening that is shown in FIG. 3A. In an exemplary embodiment, an optional sprout 48, e.g., with an upper lip and a lower lip, is depicted in FIGS. 3A and 3E as part of the structure defining the outward opening 44. One skilled in the art would understand that other simpler structures, e.g., only a lower lip without any upper lip, or more complex structures can be used to provide the outward opening or the inward opening. In the simplest embodiments, no sprout or additional structure is provided—an opening of any desired shape, e.g., circular, oval or quadrilateral, is simply cut out of the corresponding side wall of the annular gutter, as shown in FIGS. 3B and 3C, for the discharge of the condensate or any liquid.

In an advantageous but optional feature, none of the gutter's outward opening 44 is radially aligned with any of its inward opening 46; instead, each outward opening is radially staggered from an inward opening. In other words, if a radial line is drawn connecting each opening to the cooking cover's center, typically the apex 13, none of the radial lines would overlap. This staggered configuration (FIG. 3E) allows easy selection between the outward and inward opening(s) using a relatively simple switch 50, making sure that at any given time, of all the openings controlled by that switch, at least one opening is open, thus directing the condensate to discharge outside, inside, or both outside and inside the cooking chamber. Such a switch can be mechanically, magnetically, or electrically operated. An exemplary embodiment is described below of a mechanically operated switch but one skilled in the art would understand that there are other embodiments that can achieve similar goals and are intended as part of the present invention.

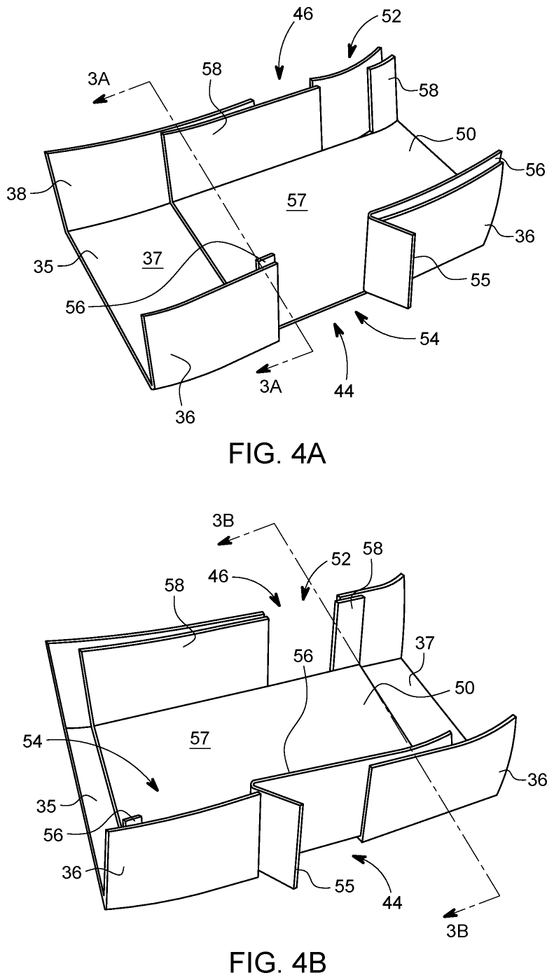

Referring now to FIGS. 4A-4B which illustrates the working principle of an exemplary switch 50 slidingly embedded or fitted within a portion of the annular gutter 35. In this particular example, much of the switch 50 closely follows the shape of a portion of the annular gutter while being slightly smaller in size so that the switch fits snugly while sitting inside the gutter. In other words, similar to the gutter, the switch 50 has a U-shaped body including a corresponding outer wall 56 and a corresponding inner wall 58 connected through a bridge 57 and defining a corresponding outward opening 54 and a corresponding non-aligned or mis-aligned inward opening 52. A switch handle 55 is connected to the switch outer wall 56 such that it is accessible from the outside during cooking. Alternately, the switch handle can be connected to another part of the cooking cover 10, e.g., the switch inner wall 58 and is accessed from inside the cover. In an embodiment, the switch's outward opening 54 and inward opening 52 match the widths of the corresponding outward opening 44 and inward opening 46 of the gutter 35, respectively.

In operation, as the operator slides the switch handle 55 to the far right “outside” position (FIG. 4A), the switch's outward opening 54 lines up with the gutter's outward opening 44. Meanwhile, the switch's inner wall 58 completely blocks the gutter's inward opening 46 and the gutter's inner wall 38 completely blocks the switch's inward opening 52. As a result, any condensate is directed to flow exclusively outward through the switch and gutter's outward openings 54 and 44 which are aligned perfectly. When the operator slides the switch handle 55 all the way to the far left “inside” position (FIG. 4B), the switch's inward opening 52 lines up with the gutter's inward opening 46. At the same time, the switch's outer wall 56 completely blocks the gutter's outward opening 44 and the gutter's outer wall 36 completely blocks the switch's outward opening 54. Any condensate is accordingly directed to flow exclusively inward through the switch and gutter's inward openings 52 and 46 which are now aligned perfectly. As one skilled in the art can readily perceive, if desired, the switch 50 can be easily designed to allow a “middle” position, where partial alignments of both sets of the corresponding openings allow discharge of the condensate both outward and inward at the same time, albeit at reduced capacities in both directions. Stops and markings can be made in the assembly to mark each of the above positions as would be readily understood by one skilled in the art and therefore not described in detail here.

Referring now to FIGS. 5A and 5B, in alternate embodiments according to the second aspect of the invention, the drainage member 18 is provided as an integral part of the cooking vessel 20 instead of the cooking cover 10. As part of the drainage member 18, two configurations of the storage member 19 (shown as the annular gutter 35) are illustrated as having the basic U-shape cross-section where the outer gutter wall 36 and the inner gutter wall 38 are connected through the gutter floor 37. Further, either the inner gutter wall 38 (FIG. 5A) or the outer gutter wall 36 (FIG. 5B) is fused or otherwise integral to the outer wall 24 of the cooking vessel. The switch 50 can be provided to sit snugly inside the annular gutter 35 as described above in connection with the preceding embodiment and is slidingly operable to control the direction of condensate drainage. For brevity, details of the openings in both the annular gutter and the switch are not repeated here, except an alternative embodiment of the switch handle 55 is illustrated here to show that the handle could be constructed as a knob connected to one of the switch walls and slides in a slot 59 in one of the gutter walls-in both FIGS. 5A and 5B, the slot 59 is shown to be situated in the outer gutter wall 36 for access from outside the cooking chamber, but it could also be situated in the inner gutter wall 38 where access can be achieved from inside.

A cooking cover 10 matching in shape and size sits over the cooking vessel 20 when the entire system is assembled for cooking or storage. Its convex surface 12 (e.g., dome-like), similar to embodiments already described above, may be protected at the base by a slotted rim or border 42, which can have a lip 43 that sits just inside the vessel top rim 60, which here is also the top of the gutter outer wall 36. In various embodiments, the cooking vessel 20 can be a pan, a pot, a fryer, and so on.

Operation of the switch 50 in cooperation with the gutter 35 to control whether any condensate is drained outside, inside, or both simultaneously, is similar to what has been described above in connection with the preceding embodiment. However, it is noted that, in the configuration illustrated in FIG. 5A where the annular gutter 35 is situated outside the main body of the cooking vessel 20, outward gutter opening(s) 44 and outward switch opening(s) 54 can be provided on the gutter floor 37 and the switch bridge 57, respectively, and paired up to provide drainage of condensate outside of the cooking chamber. This can be done in addition to or in replacement of outward opening(s) situated in the outer side walls of the gutter and the switch, both of which have been described above in connection with the preceding embodiment. In other words, outside drainage can be provided through side opening(s) as illustrated in FIGS. 3A, 3C, and 4A, or through bottom opening(s) in the gutter floor as illustrated here in FIG. 5A, or both. In the configuration illustration in FIG. 5B, on the other hand, inward opening(s) 46 and 52 provided on the gutter floor 37 and the switch bridge 57, respectively, can be paired up to provide drainage of condensate inside the cooking chamber, in addition to or in replacement of inward opening(s) situated in the inner side walls of the gutter and the switch as have been described above. In other words, inside drainage can be provided through side opening(s) as illustrated in FIGS. 3B and 4B, or through bottom opening(s) in the gutter floor as illustrated here in FIG. 5B, or both.

Referring now to FIGS. 6A and 6B, in yet other alternate embodiments according to a third aspect of the invention, the drainage member 18 is provided as a stand-alone part of the cooking system according to the present invention, separate from both the cooking vessel and the cooking cover. Once assembled, the drainage member 18 sits in between the two, with the cooking cover 10 above and the cooking vessel below. The storage member 19, as part of the drainage member 18, is shown here as the annular gutter 35 having the basic U-shape cross-section where the outer gutter wall 36 and the inner gutter wall 38 are connected through the gutter floor 37. Two configurations are illustrated where a slotted base 62 extends downward either from the inner gutter wall 38 (FIG. 6A) or the outer gutter wall 36 (FIG. 6B) for fitting over the outer wall of the cooking vessel (not shown for clarity).

The switch 50, similar to embodiments described above, can sit snugly inside the annular gutter 35 and is slidingly operable to control the direction of condensate drainage. Again, for brevity, details of the openings in both the annular gutter and the switch are not repeated here. It is noted, however, that, in the configuration illustration in FIG. 6A where the annular gutter 35 is situated outside the main body of the cooking vessel when assembled during use, outward gutter opening(s) 44 and outward switch opening(s) 54 can be provided on the gutter floor 37 and the switch bridge 57, respectively, and paired up to provide drainage of condensate outside of the cooking chamber. This can be done in addition to or in replacement of outward opening(s) situated in the outer walls of the gutter and the switch that have been described above in connection with the preceding embodiments. In the configuration illustration in FIG. 6B, on the other hand, inward gutter opening(s) 46 and inward switch opening(s) 52 can be provided on the gutter floor 37 and the switch bridge 57, respectively, and can be paired up to provide drainage of condensate inside the cooking chamber during use, in addition to or in replacement of inward opening(s) situated in the inner walls of the gutter and the switch that have been described above.

In further embodiments according to the invention, a cooking system is provided with a drainage member that provides nonstop or uninterrupted drainage of any condensate either outside or inside the cooking system or both. Simply put, such embodiments are any of the above-described or illustrated embodiments without the switch. As a result, when condensate reaches a level in the drainage member, it will automatically start to drain either outward or inward or both through the various openings described. In the case with bottom opening(s) in the bridge floor, drainage can be as soon as condensate starts to gather in the drainage/storage member.

While the present invention has been particularly shown and described with reference to the structure and methods disclosed herein and as illustrated in the drawings, it is not confined to the details set forth and this invention is intended to cover any modifications and changes as may come within the scope and spirit of the following claims. All publications and patent literature described herein are incorporated by reference in entirety to the extent permitted by applicable laws and regulations.

What is claimed is:

1. A cooking cover useful in a cooking system, comprising a dome-like convex surface having an apex on top of a base rim below, a handle disposed at said apex for handling said cover, and a drainage member disposed in proximity to said base rim for collecting condensate formed on an underside of said cover during cooking and storage, wherein said cover is configured to fit over a cooking vessel forming a cooking chamber, and said drainage member defines at least one outward opening for discharging any condensate outside said cover and at least one inward opening for discharging any condensate inside said cover, and wherein said drainage member further comprises a switch that controls whether said drainage member discharges condensate through said at least one outward opening or said at least one inward opening.

2. The cooking cover of claim 1 wherein said convex surface is made of a transparent or semi-transparent material.

3. The cooking cover of claim 2 wherein said convex surface is made of glass.

4. The cooking cover of claim 1 wherein said convex surface is made of a non-transparent material.

5. The cooking cover of claim 1 wherein said handle comprises a knob.

6. The cooking cover of claim 1 wherein said switch comprises a two-way slide.

7. The cooking cover of claim 1 wherein said drainage member discharges into at least one storage member.

8. The cooking cover of claim 7 wherein said at least one storage member comprises an annular gutter.

9. The cooking cover of claim 1 wherein each outward opening is radially staggered from an inward opening.

10. A cooking vessel, comprising a bottom that can be placed over a source of heat and a wall over said bottom terminating in a top rim above, and a drainage member disposed in proximity to said top rim for collecting and discharging condensate or liquid received during use; and
wherein said drainage member defines at least one outward opening for discharging any condensate or liquid outside said vessel and at least one inward opening for discharging any condensate or liquid inside said vessel, and wherein said drainage member further comprises a switch that controls whether said drainage member discharges condensate or liquid outside or inside said vessel.

11. The cooking vessel of claim 10, configured to fit underneath a cooking cover forming a cooking chamber.

12. The cooking vessel of claim 10, wherein said bottom is flat.

13. The cooking vessel of claim 12, selected from the group consisting of a pan, a pot, and a fryer.

14. The cooking vessel of claim 10 wherein said bottom comprises a curved surface.

15. The cooking vessel of claim 14 wherein said vessel comprises a wok.

16. The cooking vessel of claim 10 wherein said switch comprises a two-way slide.

17. The cooking vessel of claim 10, wherein said drainage member comprises a storage member which can temporarily store any condensate or liquid.

18. The cooking vessel of claim 17 wherein said at least one storage member comprises an annular gutter.

19. The cooking vessel of claim 10 wherein each outward opening is radially staggered from an inward opening.

20. A cooking system comprising a ring member useful in a cooking system, said ring member comprising a drainage member for collecting any liquid generated during use, wherein said drainage member defines at least one outward opening for discharging any liquid outside said ring member and at least one inward opening for discharging any liquid inside said ring member, and further comprises a switch that controls whether said drainage member discharges liquid outside or inside said ring member.
